(19) United States
(12) Patent Application Publication
(10) Pub. No.: US 2003/0179243 A1
(43) Pub. Date: Sep. 25, 2003

(54) Information-processing apparatus with virtual display function and display control method for use in the apparatus

(75) Inventor: Fujihito Numano, Hamura-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/352,215

(22) Filed: Jan. 28, 2003

(30) Foreign Application Priority Data
Mar. 20, 2002 (JP) 2002-079618

(51) Int. Cl. G09G 5/00

(52) U.S. Cl. 345/782

(57) ABSTRACT

An information-processing apparatus displays a screen image of a display area of a virtual screen, on a display screen of a display unit. The apparatus includes a unit for displaying on the display screen a virtual screen display window displaying a layout of the virtual screen. The virtual screen display window includes a window frame indicating a position of a window arranged on the virtual screen, and a display area frame indicating a position of the display area on the virtual screen. The apparatus also includes a unit for updating, when the window frame on the virtual screen display window has been moved, a screen image of the display screen on the basis of a relationship between the display area frame and the moved window frame on the virtual screen display window.

### CROSS-REFERENCE TO RELATED APPLICATIONS

This application is based upon and claims the benefit of priority from the prior Japanese Patent Application No. 2002-079618, filed Mar. 20, 2002, the entire contents of which are incorporated herein by reference.

### BACKGROUND OF THE INVENTION

1. Field of the Invention

The present invention relates to an information-processing apparatus with a virtual display function and a display control method for use in the apparatus.

2. Description of the Related Art

In these years, various types of notebook or laptop type portable personal computers have been developed. This kind of personal computer has a variety of functions to enhance the operability.

One of these functions is a virtual display function. The virtual display function realizes a broader desktop than the size of the actual display screen, using a broader virtual screen than the display screen of the display unit. In the virtual display function, a screen image of a partial display area on the virtual screen is displayed on the display screen (real display screen) of the display unit. The position of the partial display area on the virtual screen to be displayed on the real display screen is moved by moving the mouse pointer to the end of the real display screen (panning operation).

A multi-display system is one of virtual display functions. The multi-display system is a technique for displaying different screen images on display screens of two display units, such as an internal display unit and an external display unit of a portable personal computer. Two display areas are assigned to the virtual screen, and screen images of the two display areas are displayed on the two display units, respectively.

Recently, the size (resolution) of a usable virtual screen has been increased more and more by the enhancement in performance of a graphics chip mounted on the computer, an increase in capacity of a video memory, etc. A user can perform operational works, arranging many application windows on a broad virtual screen.

However, it remains unchanged that only a partial display area on the virtual screen can be displayed at a time on the real display screen. As the size (resolution) of the virtual screen increases, the user has greater difficulty in recognizing the screen image on the entire virtual screen.

Besides, when the user performs an operation of an application window not displayed on the real display screen, the above-mentioned panning operation needs to be done. When the panning operation has been performed, the position itself of the partial display area on the virtual screen, which is to be displayed on the real display screen, is changed. Consequently, in some cases, after the panning operation, the application window, which was displayed on the real display screen before the panning operation, may be hidden. It is therefore necessary to provide a technique for displaying on the real display screen a desired application window on the virtual screen, which is not displayed on the real display screen.

### BRIEF SUMMARY OF THE INVENTION

Embodiments of the present invention may provide an information-processing apparatus and a display control method capable of displaying on a real display screen a desired window of an off-screen area on a virtual screen, without performing a panning operation.

According to an embodiment of the present invention, there is provided an information-processing apparatus comprising: means for displaying on a display screen of a display unit a virtual screen display window that displays a layout of a virtual screen, the virtual screen display window including a window frame indicative of a position of a window arranged on the virtual screen, and a display area frame indicative of a position of a display area on the virtual screen; and means for updating, when the window frame on the virtual screen display window is moved, a screen image which is displayed on the display screen, on the basis of a relationship between the display area frame and the moved window frame on the virtual screen display window.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a system structure of a computer according to an embodiment of the present invention;

FIG. 2 illustrates a relationship between the external appearance of the computer of the embodiment, on the one hand, and a virtual screen and a real display screen, on the other;

FIG. 3 illustrates a multi-display function of the computer according to the embodiment;

FIG. 4 shows an example of the relationship between a virtual screen and a display area in the computer according to the embodiment;

FIG. 5 shows an example of a full-screen simple display window displayed on the real display screen of the computer of the embodiment;

FIG. 6 shows an example of the relationship between the virtual screen and two display areas in the computer of the embodiment;

FIG. 7 shows another example of a full-screen simple display window displayed on the real display screen of the computer of the embodiment;

FIG. 8 illustrates an example of a method of activating a full-screen simple display program in the computer of the embodiment;

FIG. 9 illustrates a display process for the full-screen simple display window and an updating process for the real display screen in the computer of the embodiment;

FIG. 10 is a flow chart illustrating a processing procedure for the full-screen simple display program in the computer of the embodiment;

FIG. 11 is a flow chart illustrating a procedure of a display process for the full-screen simple display window in the computer of the embodiment;

FIG. 12 is a flow chart illustrating a procedure of a real display screen updating process in the computer of the embodiment;

FIG. 13 is a flow chart illustrating another procedure of a real display screen updating process in the computer of the embodiment;

FIG. 14 shows an example of a shift operation for a display area frame on the full-screen simple display window in the computer of the embodiment; and

FIG. 15 illustrates an example of the real display screen updating process in the computer of the embodiment.

### DETAILED DESCRIPTION OF THE INVENTION

An embodiment of the present invention will now be described with reference to the accompanying drawings.

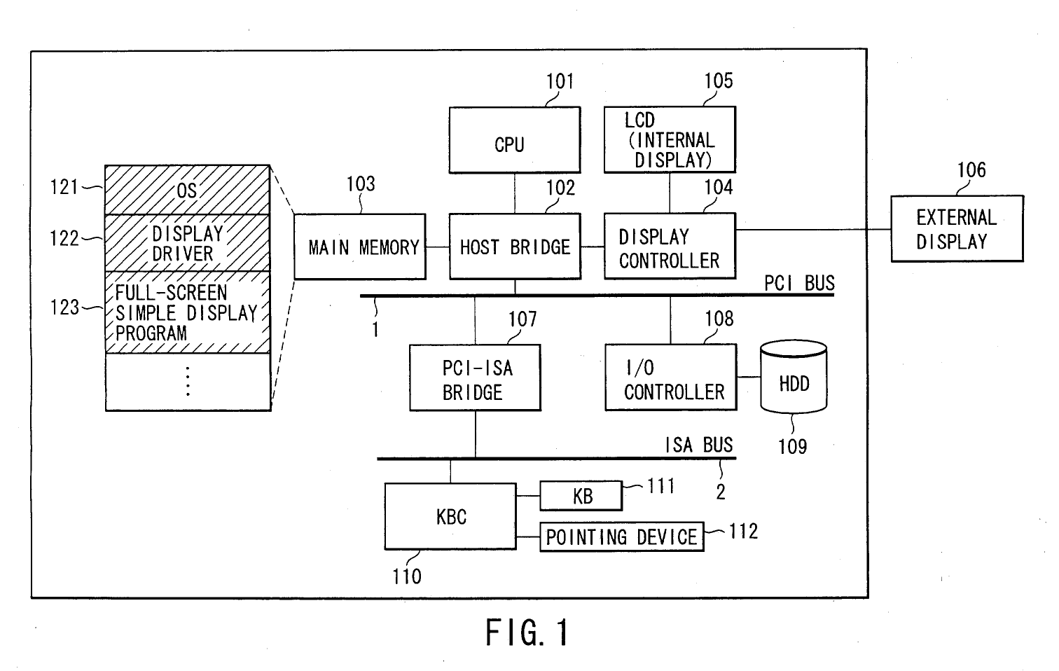

FIG. 1 shows the structure of an information-processing apparatus according to an embodiment of the present invention. The information-processing apparatus is, for example, a notebook type portable personal computer. The body of the computer is equipped with a liquid crystal display (LCD) 105 as an internal display monitor. An external display 106 may be connected, as desired, to the body of the computer.

As is shown in FIG. 1, the computer comprises a CPU 101, a host bridge 102, a main memory 103, a display controller 104, a PCI-ISA bridge 107, an I/O controller 108, a hard disk drive (HDD) 109, a keyboard controller 110, a keyboard (KB) 111, and a pointing device (mouse) 112.

The CPU 101 is a processor provided to control the operation of the computer. The CPU 101 executes an operation system (OS) 121 and a display driver 122 and other various application programs, which are loaded in the main memory 103 from the HDD 109. The display driver 122 cooperates with the OS 121 to control the display controller 104. A virtual display function is realized by the controls of the display driver 122 and the OS 121.

The virtual display function realizes a broader desktop than the size (resolution) of the actual display screen, using a virtual screen having a screen size broader than the display screen of the LCD 105. The virtual display function expands an on screen work area.

Screen image data of the virtual screen is written in a video memory provided in the display controller 104. In the virtual display function, a screen image of a partial display area on the virtual screen is displayed on the display screen (real display screen) of LCD 105. The pointing device 112 is operated to move the mouse pointer to the end of the real display screen. Thereby, the position of the partial display area on the virtual screen can be moved (panning operation).

The OS 121 supports a multi-display system. The OS 121 performs a multi-display control using the display driver 122 and display controller 104. The display controller 104 includes two graphics engines in order to display different two screen images on display screens of two display units. Under the control of the display driver 122, the display controller 104 causes two screen images, which correspond to two display areas on the virtual screen written in the video memory, to be displayed on the real display screen of LCD 105 and the real display screen of external display 106.

In addition, in the present embodiment, a full-screen simple display program 123 is prepared as a program for controlling the virtual display function. The full-screen simple display program 123, like the OS 121 and display driver 122, is loaded in the main memory 103 from the HDD 109 and executed by the CPU 101. The full-screen simple display program 123 is executed to display a virtual screen simple display window on the real display screen. The virtual screen simple display window is a window for simply displaying a screen image of the whole virtual screen on the real display screen. In order to easily showing the layout of the whole virtual screen, the virtual screen simple display window displays window frames indicating positions of application windows on the screen image of the whole virtual screen, and a display area frame indicating the position of the partial display area within the virtual screen, which is currently displayed on the real display screen. The user can recognize the screen image of the whole virtual screen by viewing the virtual screen simple display window. In addition, by moving the window frame and display area frame within the virtual screen simple display window by mouse operations, a desired application window on the virtual screen can be displayed on the real display screen.

The host bridge 102 is a bridge device that bidirectionally connects a local bus of the CPU 101 and a PCI bus 1. The host bridge 102 includes a memory controller configured to control the main memory 103. The PCI-ISA bridge 107 is a bridge device that bidirectionally connects the PCI bus 1 and an ISA bus 2. In this embodiment, the PCI-ISA bridge 107 includes various system devices such as a system timer, a DMA controller and an interrupt controller. The I/O controller 108 includes an IDE controller for controlling the HDD 109. The keyboard controller (KBC) 110 controls the keyboard (KB) 111 and pointing device (mouse) 112.

<Virtual Screen>

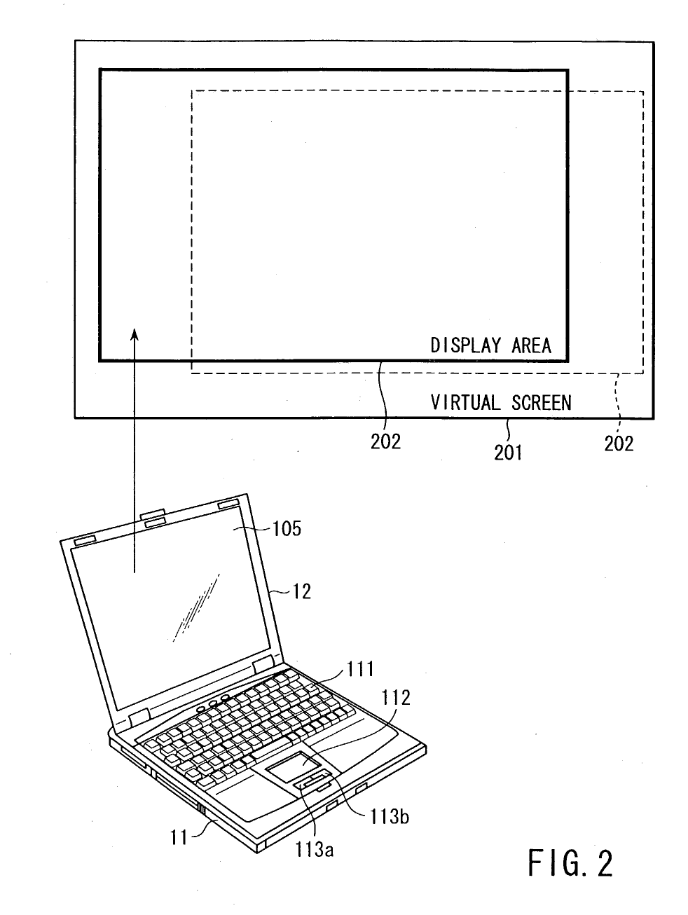

FIG. 2 illustrates a relationship between the external appearance of the computer of the embodiment, on the one hand, and a virtual screen and a real display screen, on the other. The computer comprises a computer body 11 and a display unit 12. The LCD 105 used as the display monitor of the computer is built in the display unit 12. The display unit 12 is attached to the computer body 11 so as to be rotatable between an open position and a closed position. The computer body 11 has a thin box shape. The keyboard 111, pointing device 112, operation buttons 113a and 113b of the pointing device 112, etc. are arranged on the top surface of the computer body 11.

The display screen (real display screen) of LCD 105 displays a screen image in a partial display area 202 assigned on a virtual screen 201. The size (resolution) of the display area 202 is the same as the size (resolution) of the display screen (real display screen) of LCD 105. In other words, the LCD 105 displays only the screen image in the display area 202, which is among in the screen images on the whole virtual screen 201. In this sense, it can be said that the screen image in the display area 202 is the screen image on the real display screen of LCD 105. The position of the display area 202 can be freely set, as indicated by a broken line in FIG. 2, within the virtual screen 201 by the above-mentioned panning operation or the mouse operation effected on the virtual screen simple display window.

<Multi-Display>

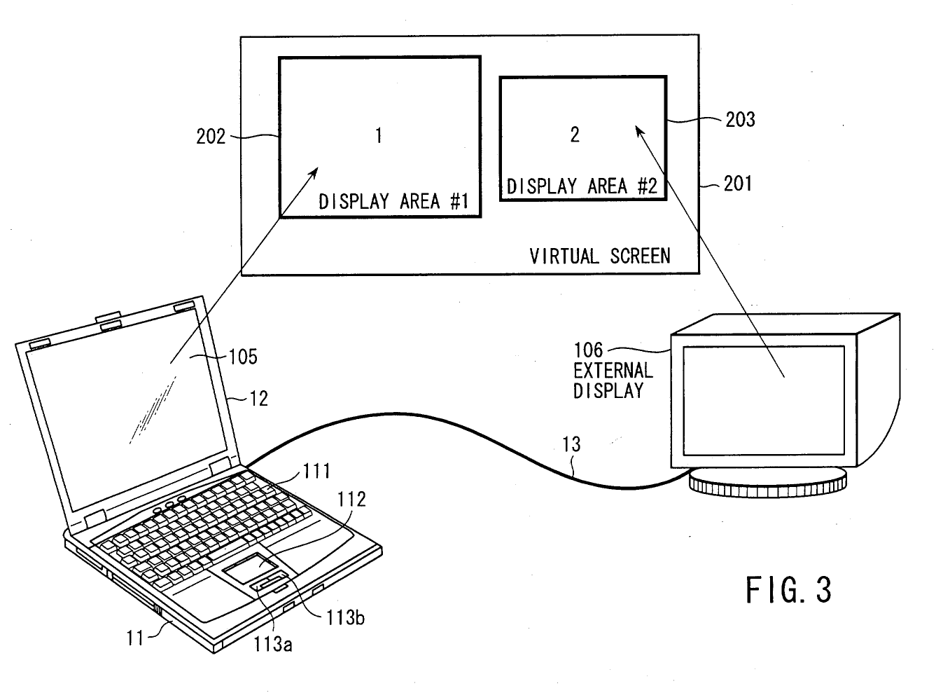

A multi-display function of the computer will now be described with reference to FIG. 3. The external display 106 is connected to the computer body 11 over a cable 13. First and second partial display areas 202 and 203 are arranged on the virtual screen 201. Of the screen images on the virtual screen 201, a screen image in the first partial display area 202 is displayed on the display screen (first real display screen) of LCD 105, and a screen image in the second partial display area 203 is displayed on the display screen (second real display screen) of external display 106. The positions of the display areas 202 and 203 can be freely set within the virtual screen 201 by the above-mentioned panning operation or the mouse operation effected on the virtual screen simple display window.

<Virtual Screen Simple Display Window>

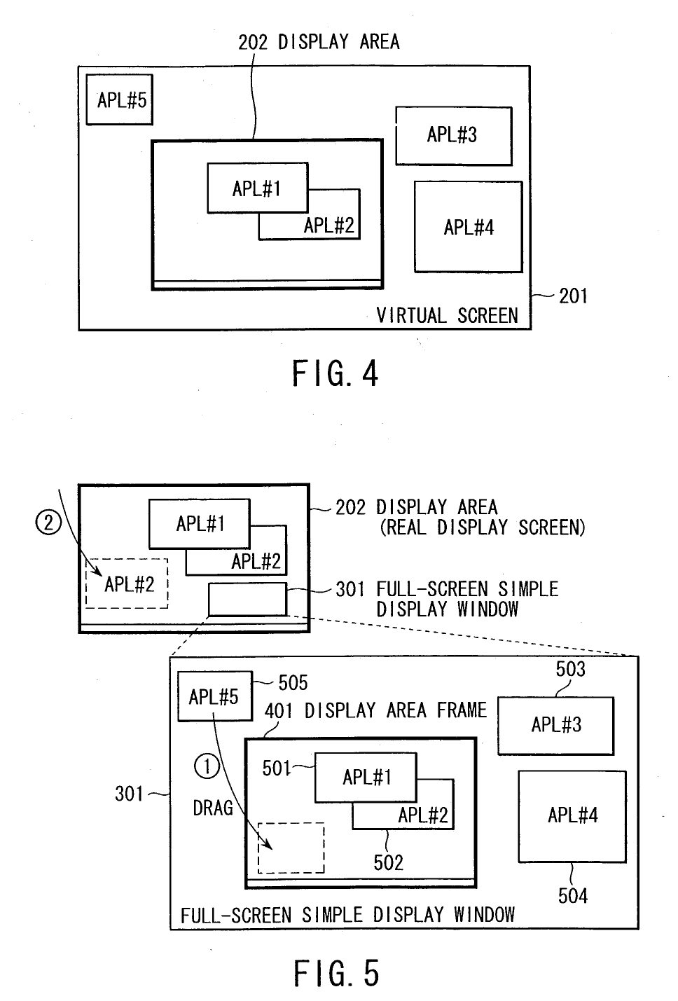

Referring to FIGS. 4 and 5, a description will now be given of the virtual screen simple display window displayed by the full-screen simple display program 123.

FIG. 4 shows an example of the relationship between the virtual screen 201 and partial display area 202 on the virtual screen 201. In this example, five application programs APL#1 to APL#5 are being executed. Application windows corresponding to the application programs APL#1 to APL#5 are arranged on the virtual screen 201. The display area 202 is arranged near the center of the virtual screen 201. Two application windows corresponding to the application programs APL#1 and APL#2 are present within the display area 202. The screen image in the display area 202 is the same as the screen image displayed on the real display screen of LCD 105. That is, two application windows corresponding to the application programs APL#1 and APL#2 are displayed on the real display screen of LCD 105, other application windows are not displayed on the real display screen of LCD 105.

FIG. 5 shows a virtual screen simple display window (hereinafter referred to as “full-screen simple display window) 301 that is displayed on the real display screen of LCD 105. The full-screen simple display window 301 is a window for displaying the outline of the screen image of the whole virtual screen 201 shown in FIG. 4 on the real display screen that displays only the screen image in the display area 202 of FIG. 4. The full-screen simple display window 301 displays a display area frame 401 and window frames 501 to 505. The display area frame 401 indicates which areas on the screen image of the whole virtual screen 201 of FIG. 4 are currently displayed on the real display screen. In short, the display area frame 401 indicates the position of the display area 202 relative to the screen image of the whole virtual screen 201. The window frames 501 to 505 indicate the positions of the application windows on the screen image of the whole virtual screen 201. In other words, the window frames 501 to 505 indicate where the application windows corresponding to the application programs APL#1 to APL#5 are arranged on the virtual screen 201 of FIG. 4. The window frames 501 to 505 display the program names (window names) of the corresponding application windows. Alternatively, the window frames 501 to 505 may display reduced screen images of the corresponding application windows in lieu of the program names.

Each of the display area frame 401 and window frames 501 to 505 can be moved to a desired position on the full-screen simple display window 301 by the moving operation of the pointing device 112. If the moving operation for the window frame has been performed on the full-screen simple display window 301, the screen image of the display area 202, that is, the screen image of the real display screen of LCD 105, is updated accordingly.

For example, the window frame 505 that is outside the display area frame 401 on the full-screen simple display window 301 is moved into the display area frame 401 by the moving operation of the pointing device 112. In this case, in accordance with the moving operation for the window frame 505 on the full-screen simple display window 301, the position of the application window corresponding to the application program APL#5, which is over the virtual screen 201 of FIG. 4, is changed from the outside to the inside of the display area 202 on the virtual screen 201. Thereby, the application window corresponding to the application program APL#5 appears on the display area 202, that is, the real display screen of LCD 105.

On the other hand, if the window frame 501, which is within the display area frame 401 on the full-screen simple display window 301, has been moved to the outside of the display area frame 401, the position of the application window corresponding to the application program APL#1, which is over the virtual screen 201 of FIG. 4, is changed from the inside to the outside of the display area 202. Thereby, the application window corresponding to the application program APL#1 disappears from the display area 202, that is, the real display screen of LCD 105.

<Virtual Screen Simple Display Window in Multi-Display System>

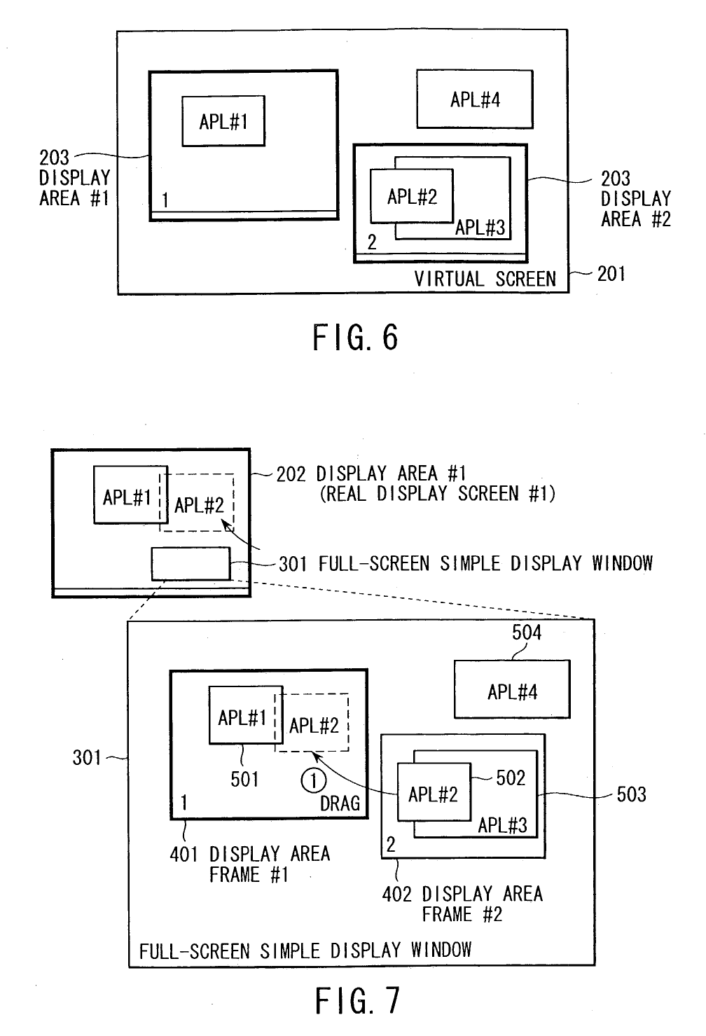

Referring to FIGS. 6 and 7, a description will now be given of the full-screen simple display window in the case of using the multi-display system.

FIG. 6 shows an example of the relationship between the virtual screen 201 and two partial display areas 202 and 203. In this example, four application programs APL#1 to APL#4 are being executed. Application windows corresponding to the application programs APL#1 to APL#4 are arranged on the virtual screen 201. The first partial display area 202 is arranged near the left side of the virtual screen 201. The second partial display area 203 is arranged near the right side of the virtual screen 201. An application window corresponding to the application program APL#1 is present within the first display area 202, and two application windows corresponding to the application programs APL#2 and APL#3 are present within the second display area 203. The screen image in the first display area 202 is displayed on the real display screen of LCD 105, and the screen image in the second display area 203 is displayed on the real display screen of external display 106. That is, the application window corresponding to the application program APL#1 is displayed on the real display screen of LCD 105, and two application windows corresponding to the application programs APL#2 and APL#3 are displayed on the real display screen of external display 106.

FIG. 7 shows a full-screen simple display window 301 that is displayed on the display area 202, that is, the real display screen of LCD 105. The full-screen simple display window 301 is a window for displaying the outline of the screen image of the whole virtual screen 201 shown in FIG. 6 on the real display screen of LCD 105. The full-screen simple display window 301 displays first and second display area frames 401 and 402 and window frames 501 to 504. The display area frame 401 indicates which areas on the screen image of the whole virtual screen 201 of FIG. 6 are currently displayed on the real display screen of LCD 105. The display area frame 402 indicates which areas on the screen image of the whole virtual screen 201 of FIG. 6 are currently displayed on the real display screen of external display 106. In short, the display area frames 401 and 402 indicate the positions of the display areas 202 and 203 relative to the screen image of the whole virtual screen 201. Display unit numbers “1” and “2” are displayed in the display area frames 401 and 402, respectively. The display unit number “1” indicates the LCD 105 that is the internal display, and the display unit number “2” indicates the external display 106.

The window frames 501 to 504 indicate the positions of the application windows on the screen image of the whole virtual screen 201. In other words, the window frames 501 to 504 indicate where the application windows corresponding to the application programs APL#1 to APL#4 are arranged on the virtual screen 201 of FIG. 6. The window frames 501 to 504 display the program names (window names) of the corresponding application windows. Alternatively, the window frames 501 to 504 may display reduced screen images of the corresponding application windows in lieu of the program names.

Each of the display area frames 401 and 402 and window frames 501 to 504 can be moved to a desired position on the full-screen simple display window 301 by the moving operation of the pointing device 112. If the moving operation for the window frame has been performed on the full-screen simple display window 301, the screen image of the display area 202, that is, the screen image of the real display screen of LCD 105, as well as the screen image of the display area 203, that is, the screen image of the real display screen of external display 106, is updated accordingly.

For example, the window frame 502 that is within the display area frame 402 on the full-screen simple display window 301 is moved into the display area frame 401 by the moving operation of the pointing device 112. In this case, in accordance with the moving operation for the window frame 502 on the full-screen simple display window 301, the position of the application window corresponding to the application program APL#2, which is on the virtual screen 201 of FIG. 6, is changed from the inside of second display area 203 to the inside of first display area 202. Thereby, the application window corresponding to the application program APL#2 is shifted from the second display area 203, i.e. the real display screen of external display 106, to the first display area 202, i.e. the real display screen of LCD 105.

In this manner, the position of each application window can freely be shifted only by moving each window frame on the full-screen simple display window 301. The full-screen simple display window 301 may be displayed on the real display screen of the external display 106, instead of the LCD 105.

<Full-Screen Simple Display Program>

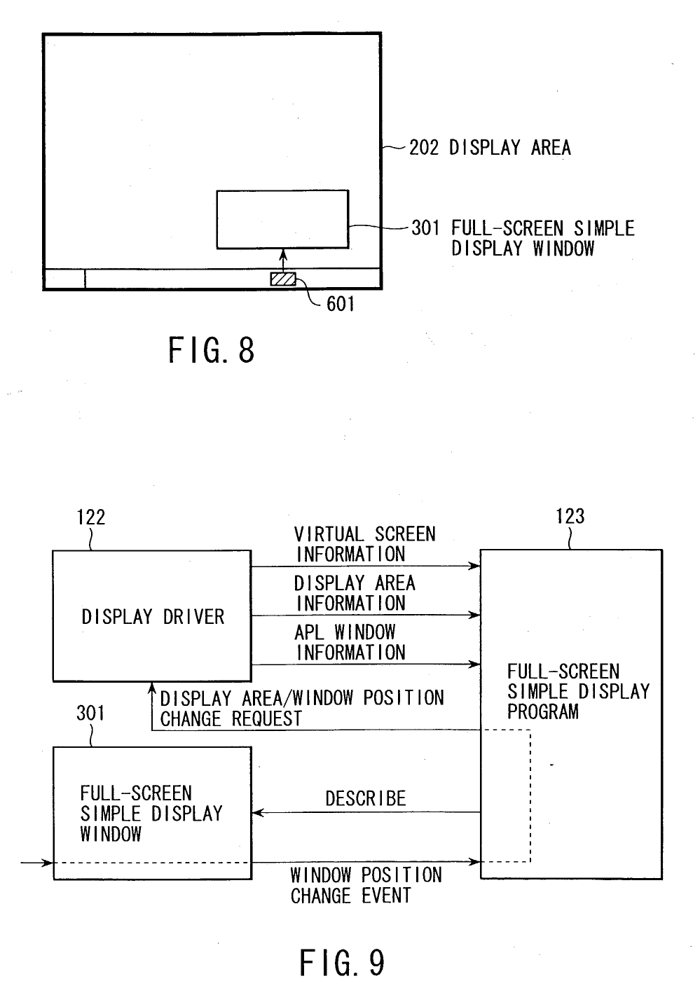

Referring to FIG. 8, a method of activating the full-screen simple display program 123 will now be described. As is shown in FIG. 8, a tray icon 601 for activating the full-screen simple display program 123 is arranged on a lower part of the desktop displayed on the real display screen. The tray icon 601 is always displayed on the lower part of the real display screen of LCD 105, irrespective of the position of the display area 202 on the virtual screen 201. If the tray icon 601 is selected by the clicking operation of pointing device 112, the full-screen simple display program 123 is activated. The full-screen simple display program 123 causes the real display screen to display the full-screen simple display window 301.

<Display of Full-Screen Simple Display Window and Updating of Real Display Screen>

With reference to FIG. 9, a display process for displaying the full-screen simple display window and an updating process for updating the real display screen, which are executed by the full-screen simple display program 123, will now be described.

The display driver 122 manages virtual screen information, display area information, and application (APL) window information. The virtual screen information is management information for managing a screen size of the entire virtual screen 201, etc. The display area information is management information relating to the display areas 202 and 203 on the virtual screen 201. The display area information manages coordinates of current positions of display areas 202 and 203, display area sizes, display unit numbers, etc. The APL window information is management information relating to the application windows on the virtual screen 201. The APL window information manages coordinates of current positions of the application windows, window sizes, program names, etc.

The full-screen simple display program 123 periodically acquires the virtual screen information, display area information and APL window information from the display driver 122. Based on the acquired virtual screen information, display area information and APL window information, the full-screen simple display program 123 generates the display area frames 401 and 402 and application window frames on the full-screen simple display window 301. Thus, the screen image data of the full-screen simple display window 301 including the display area frames 401 and 402 and application window frames is produced. The produced screen image of the full-screen simple display window 301 corresponds to the current screen image of virtual screen 201. The produced screen image of the full-screen simple display window 301 is displayed on the real display screen of LCD 105.

When an event of window position change has occurred on the full-screen simple display window 301, that is, when the user has operated the pointing device 112 to move the position of the window frame or display area frame 401, 402 on the full-screen simple display window 301, the full-screen simple display program 123 alters the position of the associated application window or display area 202, 203 on the virtual screen 201 in accordance with the moving operation. Thus, the screen images of the real display screens of the LCD 105 and external display 106 are updated. In this case, the full-screen simple display program 123 sends to the display driver 122 a display area/window position change request including a movement destination position of the moved application window or a movement destination position of the moved display area 202, 203. Thereby, the full-screen simple display program 123 instructs the display driver 122 to change the position of the application window or display area 202, 203 on the virtual screen 201.

<Processing Procedures Executed by Full-Screen Simple Display Program>

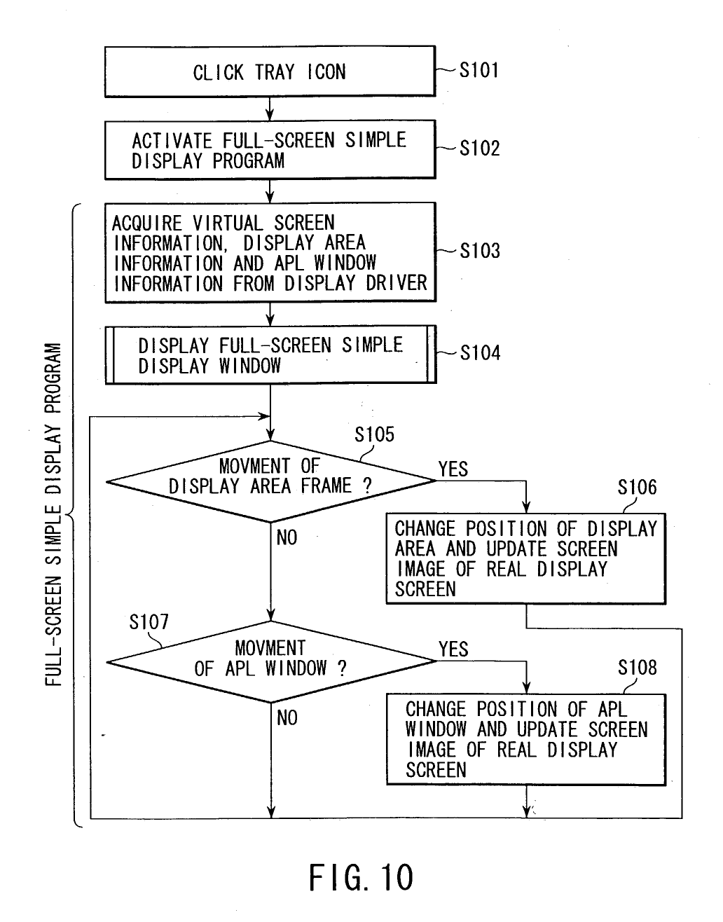

With reference to flow charts of FIGS. 10 to 13, a series of processing procedures to be executed by the full-screen simple display program 123 will now be described.

When the user has clicked the tray icon 601 (step S101), the full-screen simple display program 123 will be activated (step S102). To start with, the full-screen simple display program 123 acquires virtual screen information, display area information and APL window information from the display driver 122 (step S103). Based on the virtual screen information, display area information and APL window information, the full-screen simple display program 123 executes a display process for displaying the full-screen simple display window 301 on the real display screen of LCD 105 (step 104).

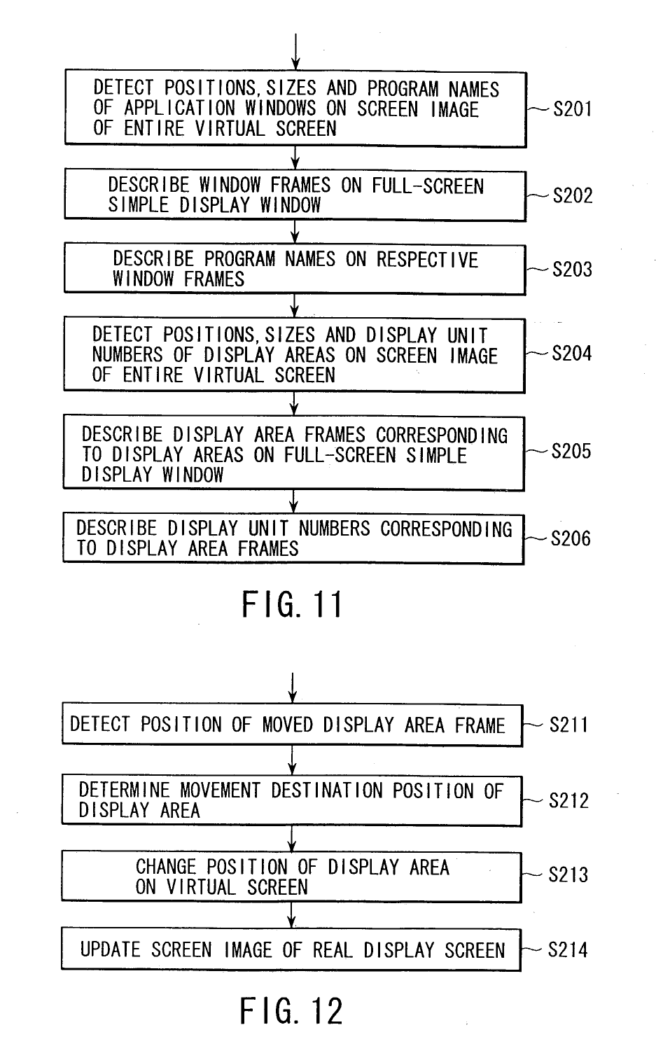

In this display process, a procedure illustrated in the flow chart of FIG. 11 is executed by the full-screen simple display program 123. To begin with, based on the acquired APL window information, the following information is detected: positions (coordinates) of the application windows on the screen image of the entire virtual screen 201, window sizes, and program names (step S201). Then, window frames corresponding to the application windows are described on the full-screen simple display window 301 opened on the real display screen of LCD 105 (step S202). In the respective window frames, the associated program names are described (step S203). Thereafter, based on the acquired display area information, the following information is detected: positions (coordinates) of display areas 202 and 203 on the screen image of the entire virtual screen 201, display area sizes, display unit numbers, etc. (step S204). The display area frames 401 and 402 corresponding to the display areas 202 and 203 are described on the full-screen simple display window 301 (step S205). Further, in the display area frames 401 and 402, the associated display unit numbers are described (step S206). In this way, the full-screen simple display window 301 including the display area frames 401 and 402 and application window frames is generated, and it is displayed on the real display screen of LCD 105. In a case where images of the associated application windows, instead of the program names, are displayed in the window frames, the full-screen simple display program 123 acquires the images of the application windows from the video memory through the display driver 122. The full-screen simple display program 123 displays reduced images of the acquired images on the corresponding window frames.

After the full-screen simple display window 301 has been displayed, the following process is executed each time an event of a window position change occurs on the full-screen simple display window 301.

When the position of the display area frame 401 or 402 has been shifted on the full-screen simple display window 301 (YES in step S105 in FIG. 10), the full-screen simple display program 123 changes the position of the display area 202 or 202 on the virtual screen 201, which corresponds to the moved display area frame 401 or 402, thus executing the screen image updating process for updating the screen image on the LCD 105 or external display 106 (step S106). In this screen image updating process, the procedure illustrated in the flow chart of FIG. 12 is executed by the full-screen simple display program 123.

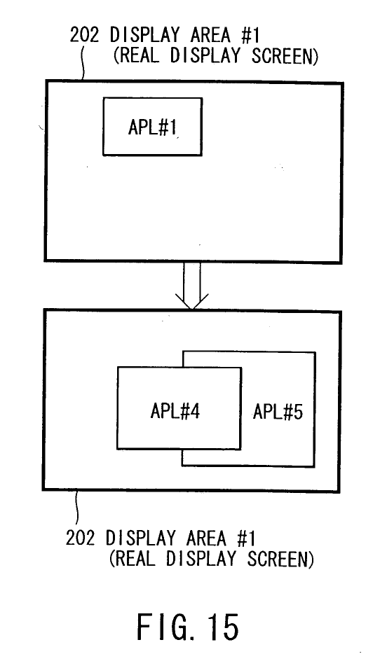

To start with, with respect to the display area frame that has been moved, the position (coordinates) of the moved display area frame on the full-screen simple display window 301 is detected (step S211). Then, based on the position (coordinates) of the moved display area frame on the full-screen simple display window 301, a shift destination position (coordinates) of the associated display area on the virtual screen 201 is determined (step S212). The shift destination position (coordinates) is informed to the display driver 122 from the full-screen simple display program 123, whereby the position of the associated display area on the virtual screen 201 is changed, and the screen image of the real display screen corresponding to the display area is updated (step S213, S214). FIGS. 14 and 15 show examples of the updating of the real display screen in the case where the first display area frame 401 has been shifted. When the first display area frame 401 on the full-screen simple display window 301 has been shifted from the position indicated by a solid line to the position indicated by a broken line, the real display screen of LCD 105, which displays the screen image of first display area 202, is updated, as shown in FIG. 15.

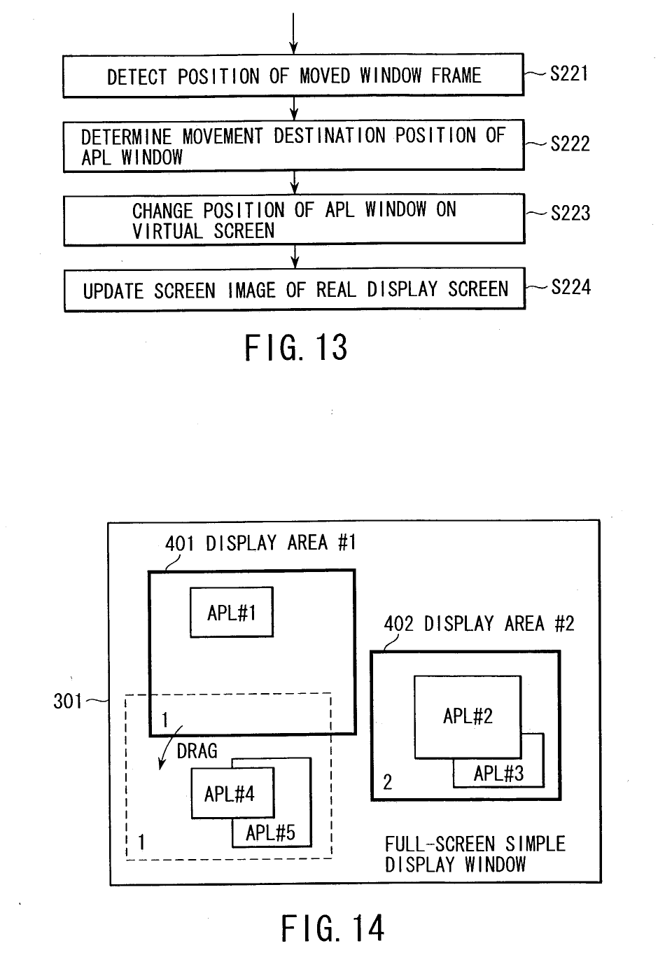

When the position of the window frame on the full-screen simple display window 301 has been shifted (YES in step S107 in FIG. 10), the full-screen simple display program 123 alters the position of the application window on the virtual screen 201, which corresponds to the shifted window frame, and executes the screen image updating process for updating the screen image on the LCD 105 or external display 106 (step S108). In the screen image updating process, the procedure illustrated in the flow chart of FIG. 13 is executed by the full-screen simple display program 123.

At first, with respect to the window frame that has been moved, the position (coordinates) of the moved window frame on the full-screen simple display window 301 is detected (step S221). Then, based on the position (coordinates) of the moved widow frame, a shift destination position (coordinates) of the associated application window on the virtual screen 201 is determined (step S222). The shift destination position (coordinates) is informed to the display driver 122 from the full-screen simple display program 123, whereby the position of the associated application window on the virtual screen 201 is changed, and the screen image of the real display screen is updated (step S223, S224).

As has been described above, according to the present embodiment, if the user has moved the position of the window frame on the full-screen simple display window 301 by means of the mouse operation or the like, the screen image on the real display screen is automatically updated such that the change in positional relationship between the window frame and display area frame on the full-screen simple display window 301 is reflected on the screen image on the real display screen. For example, by moving the window frame from the outside of the display area frame 401 (or 402) to the inside thereof on the full-screen simple display window 301, the application window corresponding to this window frame can be displayed on the real display screen. In addition, by moving the window frame from the inside of the display area frame 401 (or 402) to the outside thereof on the full-screen simple display window 301, the application window corresponding to the window frame can be made to disappear from the real display screen. Thereby, the screen image of the entire virtual screen 201 can easily be grasped from the full-screen simple display window 301, and a desired application window on the virtual screen 201 can be displayed on the real display screen without performing the panning operation.

All the display control functions of the present embodiment using the full-screen simple display window 301 are realized by the computer program. Therefore, if the computer program is stored in a computer-readable storage medium, the same advantages as with the present embodiment can be obtained only by installing this program in an ordinary computer through the recording medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information-processing apparatus comprising:
means for displaying on a display screen of a display unit a virtual screen display window that displays a layout of a virtual screen, the virtual screen display window including a window frame indicative of a position of a window arranged on the virtual screen, and a display area frame indicative of a position of a display area on the virtual screen; and
means for updating, when the window frame on the virtual screen display window is moved, a screen image which is displayed on the display screen, on the basis of a relationship between the display area frame and the moved window frame on the virtual screen display window.

2. The information-processing apparatus according to claim 1, wherein the means for displaying the virtual screen display window includes:
means for detecting a position of the window on the virtual screen;
means for displaying the window frame on the virtual screen display window, on the basis of the detected position of the window;
means for detecting a position of the display area on the virtual screen; and
means for displaying the display area frame on the virtual screen display window, on the basis of the detected position of the display area.

3. The information-processing apparatus according to claim 1, wherein the means for displaying the virtual screen display window includes:
means for displaying on the window frame of the virtual screen display window a program name corresponding to the window on the virtual screen.

4. The information-processing apparatus according to claim 1, wherein the means for displaying the virtual screen display window includes:
means for displaying on the window frame of the virtual screen display window a reduced screen image of the window on the virtual screen.

5. The information-processing apparatus according to claim 1, further comprising:
means for changing, when the display area frame on the virtual screen display window is moved, a position of the display area on the virtual screen, which is to be displayed on the display screen, on the basis of a position of the moved display area frame on the virtual screen display window.

6. The information-processing apparatus according to claim 1, wherein the means for updating the screen image of the display screen includes:
means for detecting a position of the moved window frame on the virtual screen display window; and
means for changing a position of the window on the virtual screen on the basis of the detected position of the moved window frame.

7. An information-processing apparatus which displays screen images of first and second display areas of a virtual screen, on first and second display screens of first and second display units, the apparatus comprising:
means for displaying on one of the first and second display screens a virtual screen display window that displays a layout of the virtual screen, the virtual screen display window including a window frame indicative of a position of a window arranged on the virtual screen, and first and second display area frames indicative of positions of the first and second display areas on the virtual screen; and
means for updating, when the window frame on the virtual screen display window is moved, screen images of the first and second display screens, on the basis of a relationship between the first and second display area frames and the moved window frame on the virtual screen display window.

8. The information-processing apparatus according to claim 7, wherein the means for displaying the virtual screen display window includes:
means for detecting a position of the window on the virtual screen;
means for displaying the window frame on the virtual screen display window, on the basis of the detected position of the window;
means for detecting a position of the first display area on the virtual screen;
means for displaying the first display area frame on the virtual screen display window, on the basis of the detected position of the first display area;
means for detecting a position of the second display area on the virtual screen; and
means for displaying the second display area frame on the virtual screen display window, on the basis of the detected position of the second display area.

9. The information-processing apparatus according to claim 7, further comprising:
means for changing, when one of the first and second display area frames on the virtual screen display window is moved, a position of one of the first and second display areas on the virtual screen, which is to be displayed on one of the first and second display screens, on the basis of a position of said moved one of the first and second display area frames on the virtual screen display window.

10. A method of controlling a display screen of a display unit, the display screen displaying a screen image of a display area of a virtual screen, the method comprising:
displaying on the display screen a virtual screen display window that displays a layout of the virtual screen, the virtual screen display window including a window frame indicative of a position of a window arranged on the virtual screen, and a display area frame indicative of a position of said display area on the virtual screen; and
updating, when the window frame on the virtual screen display window is moved, a screen image which is displayed on the display screen, on the basis of a relationship between the display area frame and the moved window frame on the virtual screen display window.

11. The method according to claim 10, wherein said displaying of the virtual screen display window includes:
detecting a position of the window on the virtual screen;
displaying the window frame on the virtual screen display window, on the basis of the detected position of the window;
detecting a position of the display area on the virtual screen; and
displaying the display area frame on the virtual screen display window, on the basis of the detected position of the display area.

12. The method according to claim 10, further comprising:
changing, when the display area frame on the virtual screen display window is moved, a position of the display area on the virtual screen, which is to be displayed on the display screen, on the basis of a position of the moved display area frame on the virtual screen display window.

13. The method according to claim 10, wherein said updating of the screen image of the display screen includes:
detecting a position of the moved window frame on the virtual screen display window; and
changing a position of the window on the virtual screen on the basis of the detected position of the moved window frame.

14. A method of controlling first and second display screens of first and second display units, the first and second display screens displaying screen images of first and second display areas of a virtual screen, the method comprising:
displaying on one of the first and second display screens a virtual screen display window that displays a layout of the virtual screen, the virtual screen display window including a window frame indicative of a position of a window arranged on the virtual screen, and first and second display area frames indicative of positions of the first and second display areas on the virtual screen; and
updating, when the window frame on the virtual screen display window is moved, screen images of the first and second display screens, on the basis of a relationship between the first and second display area frames and the moved window frame on the virtual screen display window.

15. The method according to claim 14, further comprising:
changing, when one of the first and second display area frames on the virtual screen display window is moved, a position of an associated one of the first and second display areas on the virtual screen, which is to be displayed on one of the first and second display screens, on the basis of a position of said moved one of the first and second display area frames on the virtual screen display window.

16. A program which is stored in a computer-readable medium and causes a computer to control a display screen of a display unit, the display screen displaying a screen image of a display area of a virtual screen, the program comprising:
causing the computer to display on the display screen a virtual screen display window that displays a layout of the virtual screen, the virtual screen display window including a window frame indicative of a position of a window arranged on the virtual screen, and a display area frame indicative of a position of said display area on the virtual screen; and
causing the computer to update, when the window frame on the virtual screen display window is moved, a screen image of the display screen, on the basis of a relationship between the display area frame and the moved window frame on the virtual screen display window.

17. A program which is stored in a computer-readable medium and causes a computer to control first and second display screens of first and second display units, the first and second display screens displaying screen images of first and second display areas of a virtual screen, the program comprising:
causing the computer to display on one of the first and second display screens a virtual screen display window that displays a layout of the virtual screen, the virtual screen display window including a window frame indicative of a position of a window arranged on the virtual screen, and first and second display area frames indicative of positions of the first and second display areas on the virtual screen; and
causing the computer to update, when the window frame on the virtual screen display window is moved, screen images of the first and second display screens, on the basis of a relationship between the first and second display area frames and the moved window frame on the virtual screen display window.
